(19) United States
(12) Patent Application Publication
(10) Pub. No.: US 2019/0042137 A1
(43) Pub. Date: Feb. 7, 2019

(54) MEMORY DEVICE WITH SEPARATE MEMORY CONTROLLERS FOR PROGRAM/ERASE AND READ OPERATIONS

(71) Applicant: Intel Corporation, Santa Clara, CA (US)

(72) Inventor: Piotr Wysocki, Gdansk (PL)

(21) Appl. No.: 15/888,970

(22) Filed: Feb. 5, 2018

(51) Int. Cl. G06F 3/06

(52) U.S. Cl. CPC G06F 3/0644; G06F 3/0679; G06F 3/0604

(57) ABSTRACT

Technology for a nonvolatile memory (NVM) device is described. The NVM device can include a NVM interface structurally configured to communicatively couple to each of a plurality of NVM subunits of a NVM. The NVM device can include a first NVM controller communicatively coupleable to each of the plurality of NVM subunits through the NVM interface. The NVM device can include a second NVM controller communicatively coupleable to each of the plurality of NVM subunits through the NVM interface. The NVM device can include a demarcation divider dynamically positionable along the NVM interface to discretely partition the NVM interface between the first NVM controller and the second NVM controller.

### BACKGROUND

Memory devices are typically provided as internal, semiconductor, integrated circuits in computers or other electronic devices. There are many different types of memory including volatile memory, for example, dynamic random access memory (DRAM) and synchronous dynamic random access memory (SDRAM), and non-volatile memory, for example, flash memory.

Flash memory devices typically use a one-transistor memory cell that allows for high memory densities, high reliability, and low power consumption. Changes in threshold voltage of the cells, through programming of a charge storage node (e.g., a floating gate or charge trap) determine the data state of each cell. Other non-volatile memories such as phase change (PRAM) use other physical phenomena such as a physical material change or polarization to determine the data state of each cell. Common uses for flash and other solid state memories include personal computers, personal digital assistants (PDAs), digital cameras, digital media players, digital recorders, games, appliances, vehicles, wireless devices, cellular telephones, and removable portable memory modules among others. The uses for such memory continue to expand.

### BRIEF DESCRIPTION OF THE DRAWINGS

Features and advantages of invention embodiments will be apparent from the detailed description which follows, taken in conjunction with the accompanying drawings, which together illustrate, by way of example, invention features; and, wherein:

FIG. 1 illustrates a nonvolatile memory (NVM) device that includes a first NVM controller for read operations and a second NVM controller for program/erase operations in accordance with an example embodiment;

FIG. 2 illustrates a NVM device that includes a first NVM controller for read operations and a second NVM controller for program/erase operations in accordance with an example embodiment;

FIG. 3 illustrates a memory system in accordance with an example embodiment;

FIG. 4 is a flowchart illustrating operations for partitioning a NVM interface of a NVM device in accordance with an example embodiment; and

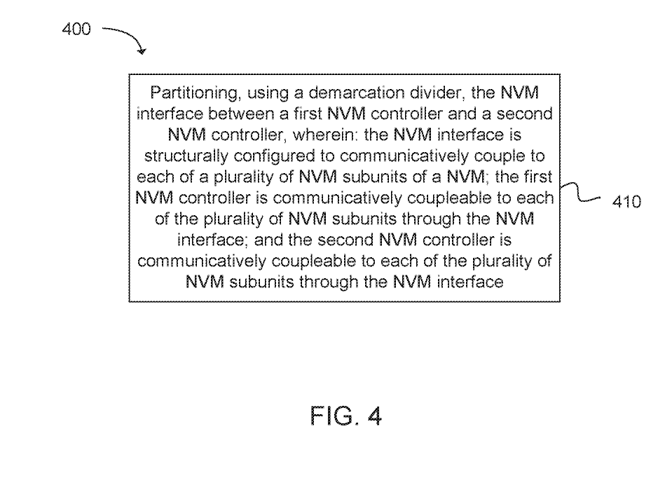

FIG. 5 illustrates a computing system that includes a data storage device in accordance with an example embodiment.

Reference will now be made to the exemplary embodiments illustrated, and specific language will be used herein to describe the same. It will nevertheless be understood that no limitation on invention scope is thereby intended.

### DESCRIPTION OF EMBODIMENTS

Before the disclosed invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various invention embodiments. One skilled in the relevant art will recognize, however, that such detailed embodiments do not limit the overall inventive concepts articulated herein, but are merely representative thereof.

As used in this specification and the appended claims, the singular forms “a,” “an” and “the” include plural referents unless the context clearly dictates otherwise. Thus, for example, reference to “a bit line” includes a plurality of such bit lines.

Reference throughout this specification to “an example” means that a particular feature, structure, or characteristic described in connection with the example is included in at least one embodiment of the present invention. Thus, appearances of the phrases “in an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

An initial overview of technology embodiments is provided below and then specific technology embodiments are described in further detail later. This initial summary is intended to aid readers in understanding the technology more quickly, but is not intended to identify key or essential technological features nor is it intended to limit the scope of the claimed subject matter. Unless defined otherwise, all technical and scientific terms used herein have the same meaning as commonly understood by one of ordinary skill in the art to which this disclosure belongs.

Traditional NAND dies can generally perform execution of one action (e.g., read, program or erase) at a time, which can be a significant limitation when reading data that was recently written with a guaranteed latency quality of service (QoS). For example, when writing a Write Ahead Log (WAL), there can be a need to read a portion of data that was previously written to this WAL. In this case, a probability of collision between a demanded read operation and an ongoing program operation on the NAND die can be increased.

In one example, in order to solve the problem of reading data that was recently written with a guaranteed latency QoS, previous solutions involved a memory device that would write data in parallel to NAND media and to a different memory location (e.g., a DRAM or 3DXP location), which would provide immediate read access (also referred to as a cache write-through approach), or to write data to a memory location (e.g., a DRAM or 3DXP location) and then perform a copy of the data to NAND media (also referred to as a cache write-back approach). In these previous solutions, the memory device would employ software that used a solid state drive (SSD) with a block interface, or software that used a SSD with an Open Channel interface. However, the previous solutions with DRAM/3DXP caching would significantly increase cost, as caching one NAND die would involve, as an example, up to 48 gigabytes (GB) (in a triple-level cell (TLC) system) or 64 GB (in a quad-level cell (QLC) system) of host memory or 3DXP capacity. In addition, the previous solution with DRAM/3DXP caching would increase a power consumption of a system, and would cause a higher host central processing unit (CPU) utilization due to the increased number of input-output (IO) operations and/or memory copy (memcpy) operations to be performed.

In another example of previous solutions, program and erase suspend features of NAND dies would decrease read latency in case of collision, but the read latency would often still be higher than specifications defined by customers. Furthermore, traditional Non-Volatile Memory Express (NVMe) SSDs include an IO determinism feature that introduced deterministic and non-deterministic states of a given NVM set (or an entire drive). However, these traditional NVMe SSDs would be unable to solve the problem of reading data that was recently written with a guaranteed latency QoS.

In the present technology, a NVM device can include a feature that optimizes for WAL writes with read IO determinism. It is noted that much of the following describes the presently disclosed technology in terms of WAL writes with read IO determinism. The present scope, however, should not be so limited, and can include numerous different uses in various systems and devices that can benefit from a dynamically dividable interface between multiple memory controllers. The NVM device can incorporate a pair of memory controllers coupled to the NVM media through a common NVM interface. The NVM interface includes a plurality of positions where the NVM interface can be dynamically divided to partition the NVM interface, along with the associated NVM, between the memory controllers. As the needs of an associated system change, the division or demarcation point that delineates the partitions can be moved to a different position, thus effectively moving NVM from one memory controller's partition into the other. It is noted that much of the present disclosure describes the disclosed technology in terms of WAL writes with read IO determinism. The present scope, however, should not be so limited, and can include numerous different uses in various systems and devices that can benefit from a dynamically dividable interface between multiple memory controllers.

In a more specific example, a NVM device can include a NVM interface communicatively coupled to each of a plurality of NVM subunits of a NVM, where each NVM subunit is independently coupled thereto. The NVM device can include a pair of NVM controllers, in this case a first NVM controller and a second NVM controller, coupled to the NVM interface. Each NVM controller is communicatively coupleable to each of the NVM subunits through the NVM interface. The NVM interface can further include a demarcation divider that is dynamically positionable along the NVM interface to discretely partition the NVM interface between the first NVM controller and the second NVM controller. Such can serve to enable the WAL writes with read IO determinism.

A first partition of the NVM can thus be controlled by the first NVM controller. In some cases, the first partition of the NVM can be prepared to include, or can already include stored data of a WAL. As such, the first partition of the NVM can be designated for performing host demanded read operations. A second partition of the NVM can be controlled by the second NVM controller, and the second partition of the NVM can be designated, in some examples, for performing program/erase operations (and not critical read operations). In other words, the first NVM controller can perform read operations with respect to the first partition of the NVM, and the second NVM controller can perform program/erase operations with respect to the second partition of the NVM. The first partition of the NVM can include a first group of NVM subunits and the second partition of the NVM can include a second group of NVM subunits, where the first group of NVM subunits is different than the second group of NVM subunits. In addition, the NVM device can include software that is aware of data placement across the NVM, and can serve to control a demarcation point that forms the first partition of the NVM that is controlled by the first NVM controller and the second partition of the NVM that is controlled by the second NVM controller.

In one configuration, the first NVM controller and the second NVM controller can be connected via an NVM interface. The NVM interface can be any type of communication interface, including a command/data bus, a fabric interface, or the like. The NVM interface can transmit various signals to the NVM (e.g., DQ, DQS, Eni, Eno, CLE, ALE, WE#, EW#, WP#, R/B#). In one example, the NVM interface can include a plurality of switches to partition the NVM interface into two interface portions—a first NVM interface and a second NVM interface. In some cases, the switches can be analog switches, while in other cases the switches can be digital switches. The first NVM interface can be under the control of, or otherwise driven by, the first NVM controller that, in some examples, performs read operations on the first partition of the NVM. The second NVM interface can be under the control of, or otherwise driven by, the second NVM controller that, in some examples, performs program/erase operations on the second partition of the NVM. In addition, the switches can be driven by one or more switch controllers, which can receive instructions regarding a desired demarcation divider (or demarcation point).

In one example, the switch controller(s) can manage an open/close state of each switch, thereby controlling a placement of the demarcation divider. The switch controller(s) can control the placement of the demarcation divider based on data placement across the NVM in the NVM device (e.g., across a NAND die in a memory device). For example, when one or more NVM subunits (or erase blocks) is populated with data using the second NVM controller (which is designated for program/erase operations), the demarcation divider can be moved to reassign the one or more NVM subunits from the second memory controller partition to the first NVM controller partition. At this point, since these NVM subunits are now assigned to the first NVM controller, the NVM subunits can be dedicated for host demanded reads. As a result, data that was recently written to an NVM subunit can be read from the NVM subunit with a latency according to a QoS.

In one configuration example, the first NVM controller can receive a first Chip Enable (CE) signal (CE0#) and the second NVM controller can receive a second CE signal (CE1#), where the first CE signal can be separate from the second CE signal. In addition, other signals (e.g., DQ, DQS, Eni, Eno, CLE, ALE, WE#, EW#, WP#, R/B#) can be shared between the first NVM controller and the second NVM controller.

Various types and configurations of NVM can be utilized in the devices and systems of the present disclosure. NVM is a storage medium that does not require power to maintain the state of data stored by the medium. NVM has traditionally been used for the task of data storage, or long-term persistent storage, but new and evolving memory technologies allow the use of NVM in roles that extend beyond traditional data storage. One example of such a role is the use of NVM as main or system memory. Non-volatile system memory (NVMsys) can combine data reliability of traditional storage with ultra-low latency and high bandwidth performance, having many advantages over traditional volatile memory, such as high density, large capacity, lower power consumption, and reduced manufacturing complexity, to name a few. Byte-addressable, write-in-place NVM such as three-dimensional (3D) cross-point memory, for example, can operate as byte-addressable memory similar to dynamic random-access memory (DRAM), or as block-addressable memory similar to NAND flash. In other words, such NVM can operate as system memory or as persistent storage memory (NVMstor). In some situations where NVM is functioning as system memory, stored data can be discarded or otherwise rendered unreadable when power to the NVMsys is interrupted. NVMsys also allows increased flexibility in data management by providing non-volatile, low-latency memory that can be located closer to a processor in a computing device. In some examples, NVMsys can reside on a DRAM bus, such that the NVMsys can provide ultra-fast DRAM-like access to data. NVMsys can also be useful in computing environments that frequently access large, complex data sets, and environments that are sensitive to downtime caused by power failures or system crashes.

Non-limiting examples of NVM can include planar or three-dimensional (3D) NAND flash memory, including single or multi-threshold-level NAND flash memory, NOR flash memory, single or multi-level Phase Change Memory (PCM), such as chalcogenide glass PCM, planar or 3D PCM, cross-point array memory, including 3D cross-point memory, non-volatile dual in-line memory module (NVDIMM)-based memory, such as flash-based (NVDIMM-F) memory, flash/DRAM-based (NVDIMM-N) memory, persistent memory-based (NVDIMM-P) memory, 3D cross-point-based NVDIMM memory, resistive RAM (ReRAM), including metal-oxide- or oxygen vacancy-based ReRAM, such as HfO2-, Hf/HfOx-, Ti/HfO2-, TiOx-, and TaOx-based ReRAM, filament-based ReRAM, such as Ag/GeS2-, ZrTe/Al2O3-, and Ag-based ReRAM, programmable metallization cell (PMC) memory, such as conductive-bridging RAM (CBRAM), silicon-oxide-nitride-oxide-silicon (SONOS) memory, ferroelectric RAM (FeRAM), ferroelectric transistor RAM (Fe-TRAM), anti-ferroelectric memory, polymer memory (e.g., ferroelectric polymer memory), magnetoresistive RAM (MRAM), write-in-place non-volatile MRAM (NVMRAM), spin-transfer torque (STT) memory, spin-orbit torque (SOT) memory, nanowire memory, electrically erasable programmable read-only memory (EEPROM), nanotube RAM (NRAM), other memristor- and thyristor-based memory, spintronic magnetic junction-based memory, magnetic tunneling junction (MTJ)-based memory, domain wall (DW)-based memory, and the like, including combinations thereof. The term “memory device” can refer to the die itself and/or to a packaged memory product. NVM can be byte or block addressable. In some examples, NVM can comply with one or more standards promulgated by the Joint Electron Device Engineering Council (JEDEC), such as JESD21-C, JESD218, JESD219, JESD220-1, JESD223B, JESD223-1, or other suitable standard (the JEDEC standards cited herein are available at www.jedec.org). In one specific example, the NVM can be 3D cross-point memory. In another specific example, the memory can be NAND or 3D NAND memory. In another specific example, the system memory can be STT memory.

In one particular configuration, a memory device can include NAND memory. The memory device can include a plurality of NAND dies, and a NAND die in the plurality of NAND dies can employ multiple fully-featured NAND die controllers coupled to a common NVM interface as described. For example, the memory device can include, for a given NAND die, a first NAND die controller and a second NAND die controller. A first partition of the NAND die can be controlled by the first NAND die controller. In one example, the first partition of the NAND die can include already stored data of a WAL, and the first partition of the NAND die can be designated for performing host demanded read operations. A second partition of the NAND die can be controlled by the second NAND die controller. In one example, the second partition of the NAND die can be designated for performing program/erase operations (and not critical read operations). In other words, the first NAND die controller can perform read operations with respect to the first partition of the NAND die, and the second NAND die controller can perform program/erase operations with respect to the second partition of the NAND die. The first partition of the NAND die can include a first group of erase blocks and the second partition of the NAND die can include a second group of erase blocks, where the first group of erase blocks is different than the second group of erase blocks. In addition, the memory device can include software that is aware of data placement across the NAND die, and can serve to control a demarcation point that forms the first partition of the NAND die that is controlled by the first NAND die controller and the second partition of the NAND die that is controlled by the second NAND die controller.

In the particular configuration described above, the first NAND memory controller and the second NAND memory controller can be connected via a single bus (or NVM interface). The one single bus can transmit various signals (e.g., DQ, DQS, Eni, Eno, CLE, ALE, WE#, EW#, WP#, R/B#) for a NAND flash array in a particular plane (or planes) of the NAND die. The bus can include a plurality of switches (e.g., analog switches), which can partition the bus into two portions—a first bus and a second bus. The first bus can be driven by the first NAND memory controller that performs read operations on the first partition of the NAND die, and the second bus can be driven by the second NAND memory controller that performs program/erase operations on the second partition of the NAND die. In addition, the analog switches can be driven by one of the first NAND memory controller or the second NAND memory controller, which can receive information regarding a desired demarcation point from a SSD controller with an additional command.

In the particular configuration described above, the first NAND memory controller can receive a first Chip Enable (CE) signal (CE0#) and the second NAND memory controller can receive a second CE signal (CE1#), and the first CE signal can be separate from the second CE signal. In addition, other signals (e.g., DQ, DQS, Eni, Eno, CLE, ALE, WE#, EW#, WP#, R/B#) can be shared between the first NAND memory controller and the second NAND memory controller. Thus, from a NAND die pinout perspective, there can be separate CE signals for the first and second NAND memory controllers, respectively, which results in the NAND die including one additional pin.

In one configuration, the NVM device that employs the novel feature related to partitioning a NVM for control by separate NVM controllers for write and program/erase operations can utilize an Open Channel SSD approach. The novel feature can improve IO Determinism (IOD) for applications using a WAL approach, and can achieve further compaction of data. Based on the novel feature, the necessity of caching data on the host side can be significantly reduced. The host can store a maximum of one NVM subunit (e.g., one erase block) of data in the cache, which can be the NVM subunit that is currently open, and for which program operations can be performed on. The novel feature can be included in an Open Channel specification or a section about Open Channel in an NVMe specification. In addition, the novel feature can be used by regular SSD firmware as well, such as during a defragmentation process.

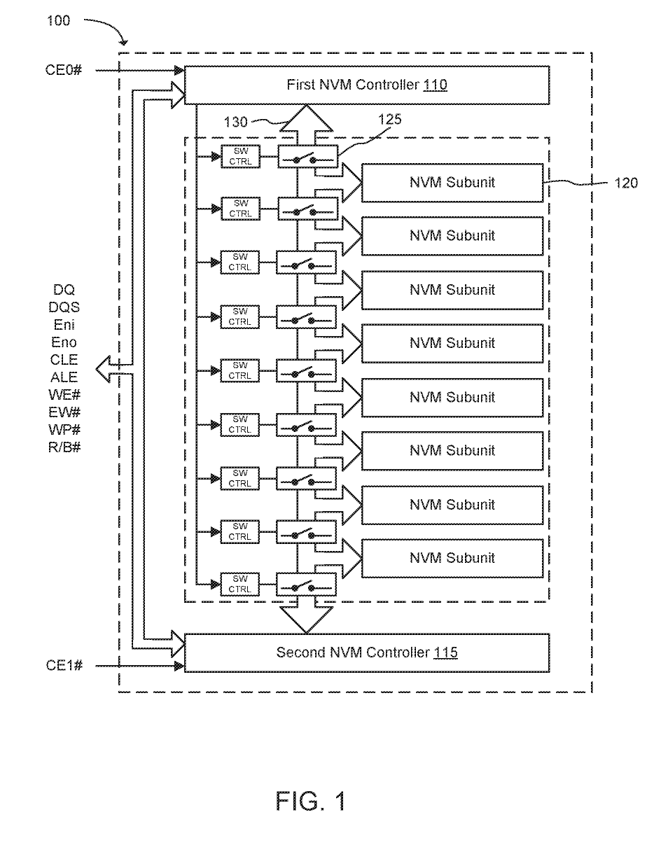

FIG. 1 illustrates an example of a nonvolatile memory (NVM) device 100 that includes a first NVM controller 110 and a second NVM controller 115, which in some examples can be for read operations and for program/erase operations, respectively. The NVM device 100 can include NVM that includes a plurality of NVM subunits 120. The NVM device 100 can include a NVM interface 130, through which each of the first NVM controller 110 and the second NVM controller 115 are coupled to the plurality of NVM subunits 120. The NVM interface 130 can communicatively couple each of the plurality of NVM subunits 120 independently. In addition, the first NVM controller 110 and the second NVM controller 115 can be communicatively coupleable to each of the plurality of NVM subunits 120 through the NVM interface 130.

In one particular example, the NVM device 100 can include a NAND die, and the first NVM controller 110 can be a first NAND die controller and the second NVM controller 115 can be a second NAND die controller. In this example, the NVM interface 130 can be a single bus, and the plurality of NVM subunits 120 can be erase blocks. In addition, in this example, the erase blocks can be included in a NAND flash array in a particular plane (or planes) of the NAND die.

In one configuration, the NVM device 100 can include a plurality of switches 125 coupled to the NVM interface 130. Each switch 125 can be positioned along the NVM interface 130 between adjacent pairs of NVM subunits 120 in the plurality of NVM subunits 120. In one example, the switches 125 can be controlled via a central switch controller (SW CTRL) (or a separate switch controller for each switch 125) to dynamically partition the NVM to form multiple partitions that each include a distinct group of NVM subunits. For example, the switch controller(s) can manage an open/close state of each switch 125 to dynamically partition the NVM to form multiple partitions. As discussed in further detail below, the NVM can be divided into separate partitions, such that one partition can be used for read operations and can be controlled by the first NVM controller 110, and another partition can be used for program/erase operations and can be controlled by the second NVM controller 115. The switches 125 can be separate switches, switches of an integrated circuit, controller, processor, or the like.

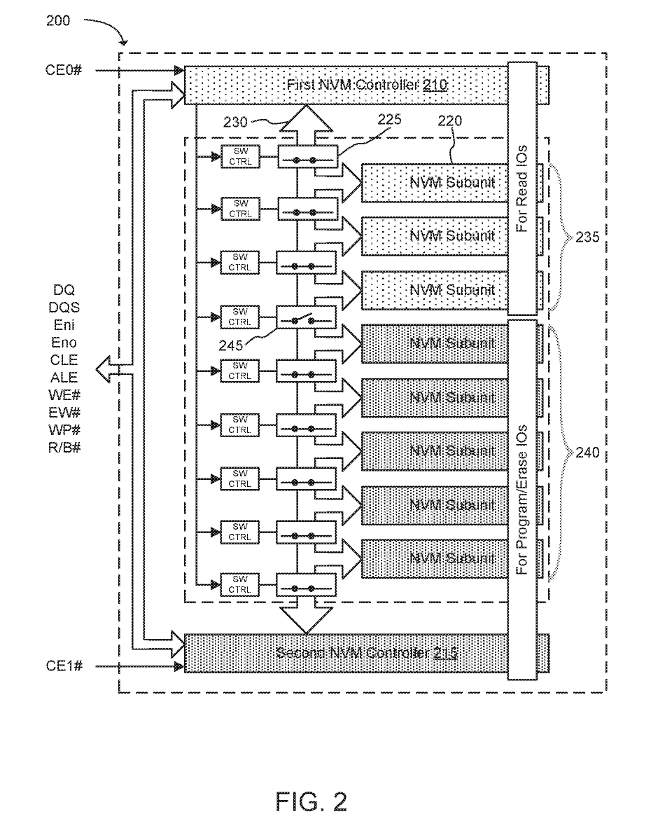

FIG. 2 illustrates an example of a nonvolatile memory (NVM) device 200 that includes a first NVM controller 210 for read operations and a second NVM controller 215 for program/erase operations. The NVM device 200 can include NVM that includes a plurality of NVM subunits 220. The NVM device 200 can include a NVM interface 230 (or fabric interface) that connects the first NVM controller 210 and the second NVM controller 215 to the plurality of NVM subunits 220. The NVM interface 230 can communicatively couple each of the plurality of NVM subunits 220. The plurality of NVM subunits 220 can be arranged along multiple planes in a 3D stacked configuration. In addition, the first NVM controller 210 and the second NVM controller 215 can be communicatively coupled to each of the plurality of NVM subunits 220 through the NVM interface 230. In some examples where the plurality of NVM subunits 220 are arranged in multiple 3D stacked planes, the first and second NVM controllers can be communicatively coupled to each of the plurality of NVM subunits 220 in each of the multiple planes. In other examples, each plane in the stacked configuration can include a dedicated first and second NVM controller.

In one particular example, the NVM device 200 can include a NAND die, and the first NVM controller 210 can be a first NAND die controller and the second NVM controller 215 can be a second NAND die controller. In this example, the NVM interface 230 can be one single bus, and the plurality of NVM subunits 220 can be erase blocks. In addition, in this example, the erase blocks can be included in a NAND flash array in a particular plane (or planes) of the NAND die.

In one configuration, the NVM device 200 includes NVM that can be partitioned to form a first partition that includes a first group of NVM subunits 235 and a second partition that includes a second group of NVM subunits 240. The first group of NVM subunits 235 can be controlled by the first NVM controller 210 and the second group of NVM subunits 240 can be controlled by the second NVM controller 215. The first partition that includes the first group of NVM subunits 235 can include already stored data of a WAL, and the first partition can be designated for performing host demanded read operations. The second partition that includes the second group of NVM subunits 240 can be designated for performing program/erase operations (and not critical read operations). In other words, the first NVM controller 210 can perform read operations with respect to the first group of NVM subunits 235, and the second NVM controller 215 can perform program/erase operations with respect to the second group of NVM subunits 240.

In one configuration, the NVM device 200 can include a plurality of switches 225. The switches 225 can be coupled to the NVM interface 230. Each switch 225 can be positioned between adjacent pairs of NVM subunits 220 in the plurality of NVM subunits 220. Each adjacent pair of NVM subunits 220 in the plurality of NVM subunits 220 can be communicatively coupled through one of the switches 225. In one example, the switches 225 can be controlled via a central switch controller (SW CTRL) (or a separate switch controller for each switch 225) to dynamically partition the NVM to form the first partition that includes the first group of NVM subunits 235 (which is controlled by the first NVM controller 210) and the second partition that includes the second group of NVM subunits 240 (which is controlled by the second NVM controller 215). For example, the switch controller(s) can manage an open/close state of each switch 225 to dynamically partition the NVM to form the first partition that corresponds to the first NVM controller 210 and the second partition that corresponds to the second NVM controller 215. In other words, based on the switches 225 being open or closed, the NVM can be partitioned between the first group of NVM subunits 235 associated with the first NVM controller 210 and the second group of NVM subunits 240 associated with the second NVM controller 215. Additionally, based on the switches 225 being open or closed, the NVM interface 230 can be partitioned to form a first NVM interface that is associated with the first group of NVM subunits 235 and the first NVM controller 210, as well as a second NVM interface that is associated with the second group of NVM subunits 240 and the second NVM controller 215.

In one example, the NVM device 200 can include a demarcation divider 245 that is dynamically positionable along the NVM interface 230. The demarcation divider 245 can discretely partition the NVM interface 230 between the first NVM controller 210 and the second NVM controller 215. In other words, the demarcation divider 245 can discretely partition the NVM to form the first partition that corresponds to the first NVM controller 210 and the second partition that corresponds to the second NVM controller 215. In one example, the demarcation divider 245 can be at least one open switch, which can divide the NVM interface 230 and the plurality of NVM subunits 220 between the first NVM controller 210 and the second NVM controller 215 into the first NVM interface that is communicatively coupled to the first group of NVM subunits 235 and the second NVM interface that is communicatively coupled to the second group of NVM subunits 240.

In the example shown in FIG. 2, the demarcation divider 245 can be an open switch that partitions the first group of NVM subunits 235 from the second group of NVM subunits 240. The switches 225 positioned above the demarcation divider 245 and the switches 225 positioned below the demarcation divider 245 can be closed switches, thereby forming the first group of NVM subunits 235 and the second group of NVM subunits 240, respectively. In addition, the switch controller can manage an open/close state of each switch 225 to dynamically position the demarcation divider 245 along the NVM interface 230.

In the example shown in FIG. 2, based on the position of the demarcation divider 245 (e.g., the open switch), the first group of NVM subunits 235 can include three NVM subunits and the second group of NVM subunits 240 can include five NVM subunits. In an alternative example, the demarcation divider 245 can be positioned differently, such that the first group of NVM subunits 235 and the second group of NVM subunits 240 can include an alternative number of NVM subunits, respectively.

In one example, the switch controller can receive information regarding a desired demarcation divider 245 (or demarcation point) from a controller, such as a memory controller, NVM device controller, or the like, (not shown) based on an additional command. The demarcation divider 245 can be controlled based on data placement across the NVM in the NVM device 200 (e.g., across a NAND die in a memory device). For example, when one or more NVM subunits 220 (or erase blocks) is populated with data using the second NVM controller 215 (which is designated for program/erase operations), the demarcation divider 245 can be moved down and the one or more NVM subunits 220 can be assigned to the first NVM controller 210. At this point, since these NVM subunits 220 are now assigned to the first NVM controller 210, the NVM subunits 220 can be dedicated for host demanded reads. As a result, data that was recently written to an NVM subunit 220 can be read from the NVM subunit 220 with a guaranteed latency QoS.

In a specific example, the first group of NVM subunits 235 can include three NVM subunits and the second group of NVM subunits 240 can include five NVM subunits, and the demarcation divider 245 can separate the first group of NVM subunits 235 from the second group of NVM subunits 240. One NVM subunit in the second group of NVM subunits 240 can be populated with data (as program operations are performed on the second group of NVM subunits 240), and that NVM subunit can be moved from the second group of NVM subunits 240 to the first group of NVM subunits 235. As a result, the first group of NVM subunits 235 can include four NVM subunits and the second group of NVM subunits 240 can include four NVM subunits. In addition, the demarcation divider 245 can be moved to separate the four NVM subunits in the first group of NVM subunits 235 from the four NVM subunits in the second group of NVM subunits 240.

In one example, when the NVM (or NAND die) is fully populated with data, the demarcation divider 245 can be set as well, allowing both the first and second NVM controllers 210, 215 to perform read operations, which can result in an increased read bandwidth.

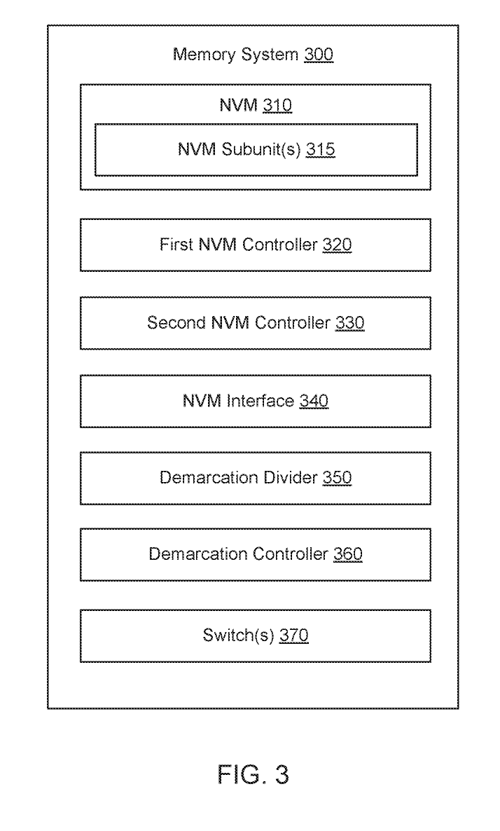

FIG. 3 illustrates an exemplary memory system 300. The memory system 300 can include a NVM 310 including a plurality of NVM subunits 315. The memory system 300 can include a first NVM controller 320 communicatively coupleable to the plurality of NVM subunits 315. The memory system 300 can include a second NVM controller 330 communicatively coupleable to the plurality of NVM subunits 315. The memory system 300 can include a NVM interface 340 communicatively coupled to each of the plurality of NVM subunits 315 and to the first NVM controller 320 and the NVM memory controller 330. The memory system 300 can include a demarcation divider 350 dynamically positionable along the NVM interface 340 to discretely partition the NVM interface 340 between the first NVM controller 320 and the second NVM controller 330. The memory system 300 can include a demarcation controller 360 communicatively coupled to the demarcation divider 350 and configured to control partitioning the NVM interface 340 and the plurality of NVM subunits 315 between the first NVM controller 320 and the second NVM controller 330.

In one example, the memory system 300 can include a plurality of switches 370 communicatively coupled to the NVM interface 340, each switch 370 can be communicatively positioned between adjacent pairs of NVM subunits of the plurality of NVM subunits 315.

In one example, the demarcation divider 350 can include at least one open switch to divide the NVM interface 340 and the plurality of NVM subunits 315 between the first NVM controller 320 and the second NVM controller 330 into a first NVM interface communicatively coupled to a first set of NVM subunits and a second NVM interface communicatively coupled to a second set of NVM subunits. In another example, the plurality of NVM subunits 315 can be arranged along multiple planes in a three-dimensional (3D) stacked configuration. In yet another example, each adjacent pair of the plurality of NVM subunits 315 can be communicatively coupled through one of the plurality of switches 370.

In one example, the demarcation controller 360 can be communicatively coupled to the plurality of switches 370. The demarcation controller 360 can manage an open/close state of each switch 370 to dynamically position the demarcation divider 350 along the NVM interface 340.

In one example, the demarcation controller 360 can include a plurality of switch controllers managed by a memory controller. Each switch controller of the plurality of switch controllers can manage the open/close state of one of the plurality of switches 370. In another example, the demarcation controller 360 can be a field-programmable gate array (FPGA), application-specific integrated controller (ASIC), or the like.

In one example, the NVM interface 340 can be a fabric interface. In another example, the plurality of NVM subunits 315 can be arranged along multiple planes in a three-dimensional (3D) stacked configuration, and at least a portion of the plurality of switches 370 can be independently switchable between planes.

Another example provides a method 400 for partitioning a NVM interface of a NVM device. The method can be executed as instructions on a machine, where the instructions are included on at least one computer readable medium or one non-transitory machine-readable storage medium. The method can include the operation of: partitioning, using a demarcation divider, the NVM interface between a first NVM controller and a second NVM controller, as in block 410. Further, the NVM interface can be structurally configured to communicatively couple to each of a plurality of NVM subunits of a NVM, the first NVM controller can be communicatively coupleable to each of the plurality of NVM subunits through the NVM interface, and the second NVM controller can be communicatively coupleable to each of the plurality of NVM subunits through the NVM interface.

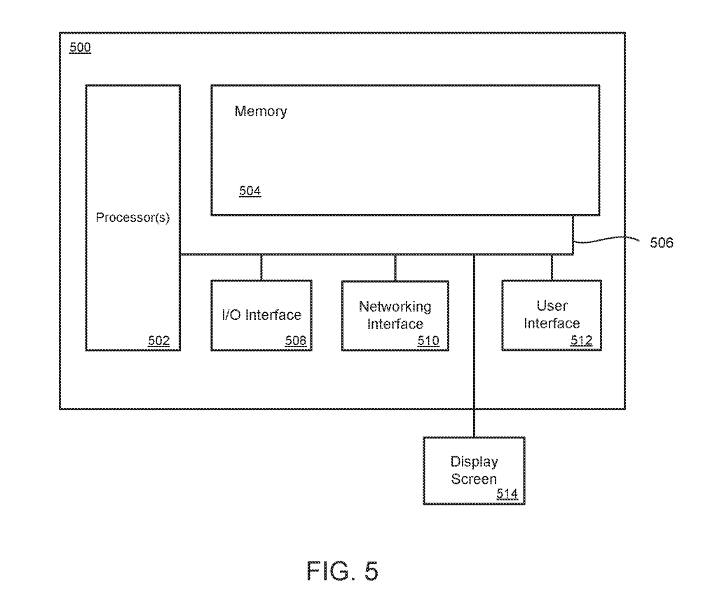

FIG. 5 illustrates a general computing system or device 500 that can be employed in the present technology. It is noted that FIG. 5 is illustrated at a very high level, and as such, the specific details and arrangements shown therein are not considered to be limiting. The computing system 500 can include a processor 502 in communication with a memory 504. The memory 504 can include any device, combination of devices, circuitry, and the like that is capable of storing, accessing, organizing, and/or retrieving data. Non-limiting examples include SANs (Storage Area Network), cloud storage networks, volatile or non-volatile RAM, phase change memory, optical media, hard-drive type media, and the like, including combinations thereof.

The computing system or device 500 additionally includes a local communication interface 506 for connectivity between the various components of the system. For example, the local communication interface 506 can be a local data bus and/or any related address or control busses as may be desired.

The computing system or device 500 can also include an I/O (input/output) interface 508 for controlling the I/O functions of the system, as well as for I/O connectivity to devices outside of the computing system 500. A network interface 510 can also be included for network connectivity. The network interface 510 can control network communications both within the system and outside of the system. The network interface can include a wired interface, a wireless interface, a Bluetooth interface, optical interface, and the like, including appropriate combinations thereof. Furthermore, the computing system 500 can additionally include a user interface 512, a display device 514, as well as various other components that would be beneficial for such a system.

The processor 502 can be a single processor or multiple processors, and the memory 504 can be a single or multiple memories. The local communication interface 506 can be used as a pathway to facilitate communication between any of a single processor, multiple processors, a single memory, multiple memories, the various interfaces, and the like, in any useful combination.

Various techniques, or certain aspects or portions thereof, can take the form of program code (i.e., instructions) embodied in tangible media, such as CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high-level procedural or object oriented programming language to communicate with a computer system. However, the program(s) can be implemented in assembly or machine language, if desired. In any case, the language can be a compiled or interpreted language, and combined with hardware implementations. Exemplary systems or devices can include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

### EXAMPLES

The following examples pertain to specific invention embodiments and point out specific features, elements, or steps that can be used or otherwise combined in achieving such embodiments.

In one example, there is provided a nonvolatile memory (NVM) device. The NVM device can comprise a NVM interface structurally configured to communicatively couple to each of a plurality of NVM subunits of a NVM. The NVM device can comprise a first NVM controller communicatively coupleable to each of the plurality of NVM subunits through the NVM interface. The NVM device can comprise a second NVM controller communicatively coupleable to each of the plurality of NVM subunits through the NVM interface. The NVM device can comprise a demarcation divider dynamically positionable along the NVM interface to discretely partition the NVM interface between the first NVM controller and the second NVM controller.

In one example of the NVM device, the NVM device further comprises the plurality of NVM subunits of the NVM.

In one example of the NVM device, the NVM device further comprises: a plurality of switches communicatively coupled to the NVM interface, wherein each switch is communicatively positioned between adjacent pairs of NVM subunits of the plurality of NVM subunits, wherein the demarcation divider comprises at least one open switch to divide the NVM interface and the plurality of NVM subunits between the first NVM controller and the second NVM controller into a first NVM interface communicatively coupled to a first set of NVM subunits and a second NVM interface communicatively coupled to a second set of NVM subunits.

In one example of the NVM device, the plurality of NVM subunits is arranged along multiple planes in a three-dimensional (3D) stacked configuration.

In one example of the NVM device, each adjacent pair of the plurality of NVM subunits is communicatively coupled through one of the plurality of switches.

In one example of the NVM device, the NVM device further comprises: a switch controller communicatively coupled to the plurality of switches, wherein the switch controller is to manage an open/close state of each switch to dynamically position the demarcation divider along the NVM interface.

In one example of the NVM device, the switch controller further comprises a plurality of switch controllers managed by a memory controller.

In one example of the NVM device, each switch controller of the plurality of switch controllers manages the open/close state of one of the plurality of switches.

In one example of the NVM device, the switch controller is a field-programmable gate array (FPGA).

In one example of the NVM device, the NVM interface is a fabric interface.

In one example of the NVM device, the plurality of NVM subunits is arranged along multiple planes in a three-dimensional (3D) stacked configuration, and at least a portion of the plurality of switches is independently switchable between planes.

In one example, there is provided a memory system. The memory system can comprise a nonvolatile memory (NVM) including a plurality of NVM subunits. The memory system can comprise a first NVM controller communicatively coupleable to the plurality of NVM subunits. The memory system can comprise a second NVM controller communicatively coupleable to the plurality of NVM subunits. The memory system can comprise a NVM interface communicatively coupled to each of the plurality of NVM subunits and to the first NVM controller and the NVM memory controller. The memory system can comprise a demarcation divider dynamically positionable along the NVM interface to discretely partition the NVM interface between the first NVM controller and the second NVM controller. The memory system can comprise a demarcation controller communicatively coupled to the demarcation divider and configured to control partitioning the NVM interface and the plurality of NVM subunits between the first NVM controller and the second NVM controller.

In one example of the memory system, the memory system further comprises: a plurality of switches communicatively coupled to the NVM interface, wherein each switch is communicatively positioned between adjacent pairs of NVM subunits of the plurality of NVM subunits, wherein the demarcation divider comprises at least one open switch to divide the NVM interface and the plurality of NVM subunits between the first NVM controller and the second NVM controller into a first NVM interface communicatively coupled to a first set of NVM subunits and a second NVM interface communicatively coupled to a second set of NVM subunits.

In one example of the memory system, the plurality of NVM subunits is arranged along multiple planes in a three-dimensional (3D) stacked configuration.

In one example of the memory system, each adjacent pair of the plurality of NVM subunits is communicatively coupled through one of the plurality of switches.

In one example of the memory system, the demarcation controller is communicatively coupled to the plurality of switches, the demarcation controller to manage an open/close state of each switch to dynamically position the demarcation divider along the NVM interface.

In one example of the memory system, the demarcation controller further comprises a plurality of switch controllers managed by a memory controller.

In one example of the memory system, each switch controller of the plurality of switch controllers manages the open/close state of one of the plurality of switches.

In one example of the memory system, the demarcation controller is a field-programmable gate array (FPGA).

In one example of the memory system, the NVM interface is a fabric interface.

In one example of the memory system, the plurality of NVM subunits is arranged along multiple planes in a three-dimensional (3D) stacked configuration, and at least a portion of the plurality of switches is independently switchable between planes.

In one example, there is provided a method for partitioning a NVM interface of a NVM device. The method can include the operation of: partitioning, using a demarcation divider, the NVM interface between a first NVM controller and a second NVM controller, wherein: the NVM interface is structurally configured to communicatively couple to each of a plurality of NVM subunits of a NVM; the first NVM controller is communicatively coupleable to each of the plurality of NVM subunits through the NVM interface; and the second NVM controller is communicatively coupleable to each of the plurality of NVM subunits through the NVM interface.

In one example of the method for partitioning the NVM interface of a NVM device, the operation of partitioning the NVM interface further comprises: partitioning the NVM interface and the plurality of NVM subunits between the first NVM controller and the second NVM controller using at least one open switch included in the demarcation divider, wherein: the NVM interface is divided into a first NVM interface communicatively coupled to a first set of NVM subunits and a second NVM interface communicatively coupled to a second set of NVM subunits; and a plurality of switches is communicatively coupled to the NVM interface, each switch communicatively positioned between adjacent pairs of NVM subunits of the plurality of NVM subunits.

In one example of the method for partitioning the NVM interface of a NVM device, the method further includes the operation of: arranging the plurality of NVM subunits along multiple planes in a three-dimensional (3D) stacked configuration.

In one example of the method for partitioning the NVM interface of a NVM device, each adjacent pair of the plurality of NVM subunits is communicatively coupled through one of the plurality of switches.

In one example of the method for partitioning the NVM interface of a NVM device, the method further includes the operation of: managing, via a switch controller communicatively coupled to the plurality of switches, an open/close state of each switch to dynamically position the demarcation divider along the NVM interface.

In one example of the method for partitioning the NVM interface of a NVM device, the switch controller further comprises a plurality of switch controllers managed by a memory controller, wherein each switch controller of the plurality of switch controllers manages the open/close state of one of the plurality of switches.

In one example of the method for partitioning the NVM interface of a NVM device, the switch controller is a field-programmable gate array (FPGA).

In one example of the method for partitioning the NVM interface of a NVM device, the NVM interface is a fabric interface.

In one example of the method for partitioning the NVM interface of a NVM device, the method further includes the operation of: arranging the plurality of NVM subunits along multiple planes in a three-dimensional (3D) stacked configuration, and at least a portion of the plurality of switches is independently switchable between planes.

While the forgoing examples are illustrative of the principles of invention embodiments in one or more particular applications, it will be apparent to those of ordinary skill in the art that numerous modifications in form, usage and details of implementation can be made without the exercise of inventive faculty, and without departing from the principles and concepts of the disclosure.

What is claimed is:

1. A nonvolatile memory (NVM) device, comprising:
a NVM interface structurally configured to communicatively couple to each of a plurality of NVM subunits of a NVM;
a first NVM controller communicatively coupleable to each of the plurality of NVM subunits through the NVM interface;
a second NVM controller communicatively coupleable to each of the plurality of NVM subunits through the NVM interface; and
a demarcation divider dynamically positionable along the NVM interface to discretely partition the NVM interface between the first NVM controller and the second NVM controller.

2. The NVM device of claim 1, further comprising the plurality of NVM subunits of the NVM.

3. The NVM device of claim 1, further comprising:
a plurality of switches communicatively coupled to the NVM interface, each switch communicatively positioned between adjacent pairs of NVM subunits of the plurality of NVM subunits;
wherein the demarcation divider comprises at least one open switch to divide the NVM interface and the plurality of NVM subunits between the first NVM controller and the second NVM controller into a first NVM interface communicatively coupled to a first set of NVM subunits and a second NVM interface communicatively coupled to a second set of NVM subunits.

4. The NVM device of claim 3, wherein the plurality of NVM subunits is arranged along multiple planes in a three-dimensional (3D) stacked configuration.

5. The NVM device of claim 3, wherein each adjacent pair of the plurality of NVM subunits is communicatively coupled through one of the plurality of switches.

6. The NVM device of claim 3, further comprising a switch controller communicatively coupled to the plurality of switches, the switch controller to manage an open/close state of each switch to dynamically position the demarcation divider along the NVM interface.

7. The NVM device of claim 6, wherein the switch controller further comprises a plurality of switch controllers managed by a memory controller.

8. The NVM device of claim 7, wherein each switch controller of the plurality of switch controllers manages the open/close state of one of the plurality of switches.

9. The NVM device of claim 6, wherein the switch controller is a field-programmable gate array (FPGA).

10. The NVM device of claim 3, wherein the plurality of NVM subunits is arranged along multiple planes in a three-dimensional (3D) stacked configuration, and at least a portion of the plurality of switches is independently switchable between planes.

11. The NVM device of claim 1, wherein the NVM interface is a fabric interface.

12. A memory system, comprising:
a nonvolatile memory (NVM) including a plurality of NVM subunits;
a first NVM controller communicatively coupleable to the plurality of NVM subunits;
a second NVM controller communicatively coupleable to the plurality of NVM subunits;
a NVM interface communicatively coupled to each of the plurality of NVM subunits and to the first NVM controller and the NVM memory controller;
a demarcation divider dynamically positionable along the NVM interface to discretely partition the NVM interface between the first NVM controller and the second NVM controller; and
a demarcation controller communicatively coupled to the demarcation divider and configured to control partitioning the NVM interface and the plurality of NVM subunits between the first NVM controller and the second NVM controller.

13. The memory system of claim 12, further comprising:
a plurality of switches communicatively coupled to the NVM interface, each switch communicatively positioned between adjacent pairs of NVM subunits of the plurality of NVM subunits;
wherein the demarcation divider comprises at least one open switch to divide the NVM interface and the plurality of NVM subunits between the first NVM controller and the second NVM controller into a first NVM interface communicatively coupled to a first set of NVM subunits and a second NVM interface communicatively coupled to a second set of NVM subunits.

14. The memory system of claim 13, wherein the plurality of NVM subunits is arranged along multiple planes in a three-dimensional (3D) stacked configuration.

15. The memory system of claim 13, wherein each adjacent pair of the plurality of NVM subunits is communicatively coupled through one of the plurality of switches.

16. The memory system of claim 13, wherein the demarcation controller is communicatively coupled to the plurality of switches, the demarcation controller to manage an open/close state of each switch to dynamically position the demarcation divider along the NVM interface.

17. The memory system of claim 16, wherein the demarcation controller further comprises a plurality of switch controllers managed by a memory controller.

18. The memory system of claim 17, wherein each switch controller of the plurality of switch controllers manages the open/close state of one of the plurality of switches.

19. The memory system of claim 16, wherein the demarcation controller is a field-programmable gate array (FPGA).

20. The memory system of claim 19, wherein the NVM interface is a fabric interface.

21. The memory system of claim 20, wherein the plurality of NVM subunits is arranged along multiple planes in a three-dimensional (3D) stacked configuration, and at least a portion of the plurality of switches is independently switchable between planes.

22. A method for partitioning a nonvolatile memory (NVM) interface of a NVM device, the method comprising:
partitioning, using a demarcation divider, the NVM interface between a first NVM controller and a second NVM controller, wherein:
the NVM interface is structurally configured to communicatively couple to each of a plurality of NVM subunits of a NVM;
the first NVM controller is communicatively coupleable to each of the plurality of NVM subunits through the NVM interface; and
the second NVM controller is communicatively coupleable to each of the plurality of NVM subunits through the NVM interface.

23. The method of claim 22, wherein partitioning the NVM interface further comprises:
partitioning the NVM interface and the plurality of NVM subunits between the first NVM controller and the second NVM controller using at least one open switch included in the demarcation divider, wherein:
the NVM interface is divided into a first NVM interface communicatively coupled to a first set of NVM subunits and a second NVM interface communicatively coupled to a second set of NVM subunits; and
a plurality of switches is communicatively coupled to the NVM interface, each switch communicatively positioned between adjacent pairs of NVM subunits of the plurality of NVM subunits.

24. The method of claim 23, further comprising managing, via a switch controller communicatively coupled to the plurality of switches, an open/close state of each switch to dynamically position the demarcation divider along the NVM interface.
